(19) United States
(12) Patent Application Publication
(10) Pub. No.: US 2015/0058430 A1
(43) Pub. Date: Feb. 26, 2015

(54) METHOD AND SYSTEM FOR CHANGING A KEYPAD LANGUAGE AND ELECTRONIC DEVICE THEREOF

(71) Applicant: Samsung Electronics Co., Ltd., Gyeonggi-do (KR)

(72) Inventor: Rashmi T. SHANKARAPPA, Bangalore-37 (IN)

(73) Assignee: Samsung Electronics Co., Ltd.

(21) Appl. No.: 14/467,962

(22) Filed: Aug. 25, 2014

(30) Foreign Application Priority Data
Aug. 23, 2013 (IN) 3729/CHE/2013

(51) Int. Cl. H04L 12/58; G06F 17/28

(52) U.S. Cl. CPC H04L 51/046; G06F 17/289
USPC 709/206

(57) ABSTRACT

A method, apparatus, and system for enabling a sender to communicate with a receiver based on a preferred language of the receiver is provided. The method provides the desired keypad language to the sender for typing a text message, mail or a chat message to the receiver. The method suggests the keypad language based on the preferred language of the sender or the last language used by the sender for communicating with the receiver or based on the languages set by the receiver in one or more social networks. Further, the method synchronizes the contacts of the sender, contacts in different communication applications used by the sender and contacts in different social networks of the sender with a cloud or a database and provides the preferred keypad language to the sender.

### PRIORITY

This application claims priority under 35 U.S.C. §119(a) to an Indian Patent Application Serial Number 3729/CHE/2013 filed on Aug. 23, 2013 in the Indian Patent Office, the entire disclosure of which is incorporated herein by reference.

### BACKGROUND OF THE INVENTION

1. Field of the Invention

The present disclosure relates generally to a method and system for changing a keypad language and an electronic device thereof.

2. Description of the Related Art

Handheld devices (for example, mobile phones) have become more powerful with the inclusion of features such as cameras, address books, calendars, games and so on. One key element in the efficient design of a handheld device is the user interface, which typically includes one or more input components for entering text. However, typical text input components suffer from efficiency issues with the limited resources of a mobile phone or while inputting text in multiple languages.

Different types of devices enable messaging between users. The problem while sending a message to a user is that the language that is preferred by a sender of a message may not be the same as that preferred by a recipient of the message. With present communication systems, if the sender prefers communicating in English while the receiver prefers communicating in another language such as Hindi, a message sent by the sender will most probably be in English and the receiver of the message may have trouble understanding the message. The receiver may have to use a translation tool to translate the message into Hindi in order to understand the message.

In the above described system, the sender may request a translation tool for translation of messages before delivering to the receiver of the message, when the sender is a subscriber of a Rich Communication Service (RCS). The sender may request translation of messages, irrespective of the capabilities of the network and device at the receiver's end. However, the sender has to make the request manually and must also be aware of the preferred language of the receiver.

### SUMMARY

The present disclosure has been made to address at least the problems and disadvantages described above, and to provide at least the advantages described below.

Accordingly, an aspect of the present disclosure is to provide a method and system for dynamically changing a keypad language of a sender based on a preferred language of a receiver. Another aspect of the present disclosure is to provide a method and system for providing a keypad language to a user by synchronizing contacts in all of a sender's devices and communication applications with a cloud.

In accordance with an aspect of the present disclosure, a method for enabling a sender to communicate with a receiver, based on a preferred language of the receiver is provided. The method includes identifying the preferred language of the receiver, based on at least one parameter and providing the identified preferred language as a keypad language to the sender for communicating with the receiver.

In accordance with another aspect of the present disclosure, an apparatus for enabling a sender to communicate with a receiver, based on a preferred language of the receiver is provided. The apparatus includes an integrated circuit configured to include at least one processor and at least one memory. The at least one memory is configured to include a computer program code. The computer program code is configured to perform the steps of identifying the preferred language of the receiver, based on at least one parameter; and providing the identified preferred language as a keypad language to the sender for communicating with the receiver.

In accordance with another aspect of the present disclosure, a system for enabling a sender to communicate with a receiver, based on a preferred language of the receiver, is provided. The system includes at least one device; at least one application on the at least device; and at least one social network on the at least one device, where the system is configured to perform the steps of identifying the preferred language of the receiver, based on at least one parameter, and providing the identified preferred language as a keypad language to the sender for communicating with the receiver.

### BRIEF DESCRIPTION OF THE DRAWINGS

The above and other aspects, features, and advantages of the present disclosure will be more apparent from the following detailed description taken in conjunction with the accompanying drawings, in which:

FIG. 1 is a block diagram illustrating a system for dynamically changing a keypad language of a sender, based on the preferred language of the receiver, according to an embodiment of the present disclosure;

FIG. 2 is a flowchart illustrating a method of providing a keypad language to a sender, according to an embodiment of the present disclosure; and

FIG. 3 is a flowchart illustrates a method of setting preferred languages, by a sender, for communicating with a receiver, according to an embodiment of the present disclosure; and

FIG. 4 illustrates an apparatus implementing the method and system for enabling a sender to communicate with a receiver, based on the preferred language of the receiver, according to an embodiment of the present disclosure.

### DETAILED DESCRIPTION OF EMBODIMENTS OF THE PRESENT INVENTION

The embodiments of the present disclosure and the various features and advantageous details thereof are explained more fully with reference to the accompanying drawings. Descriptions of well-known components and processing techniques are omitted so as to not unnecessarily obscure the embodiments herein. The examples used herein are intended merely to facilitate an understanding of ways in which the embodiments herein can be practiced and to further enable those of skill in the art to practice the embodiments herein. Accordingly, the examples should not be construed as limiting the scope of the embodiments herein.

The embodiments herein achieve a method and system for dynamically changing the keypad language of a sender for communicating with a receiver based on the preferred language of the receiver. The method provides the desired keypad language to the sender for typing a Short Message Service (SMS) text message or a mail or a chat message to the receiver. The method suggests the keypad language to a sender based on the preferred language set by the sender in the device or communication application or on the last language used by the sender for communicating with the receiver or on the languages set by the receiver in any of the social networks. Further, the method synchronizes the contacts of the sender in the device, contacts in communication applications and contacts in social networks with a cloud or a database and provides the preferred keypad language to the sender.

According to an embodiment of the present disclosure, the method synchronizes all the contacts present in all of the devices of the sender and the social networks and obtains the keypad language based on the languages set by the contacts of the receiver across different social networks.

For example, consider that the sender has set languages A, B and C in his/her social network. If the sender wants to communicate with the receiver, then the method determines the languages set by the receiver across different social networks and provides the common language (if it exists) between the sender and the receiver as the keypad language to the sender. If there is no common language between the sender and the receiver, then the method provides a default keypad language to the sender.

According to an embodiment of the present disclosure, when a sender adds a contact to his/her device or to a communication application, the method provides one or more fields to the sender which allows the user to identify multiple values (i.e. languages) for the preferred language or languages associated with the contact. That is, the sender can add multiple values of preferred languages in the one or more fields. After every synchronization with the cloud, these fields are updated in the device dynamically. During the synchronization, the values are fetched from all of the social networks and the other devices of the sender (for example the sender's tablet, Personal Digital Assistant (PDA) and so on) and the list of preferred languages is updated in the sender's device.

The method suggests, to the sender, the last used language as the keypad language, for communicating with the receiver, by comparing the values from all of the sender's social networks and other user devices. All of the contacts in the various sender devices are synchronized with the cloud and the last used language for a contact is determined and provided to the sender as a keypad language, when the sender tries to communicate with that contact.

Throughout the description, the terms “cloud” and “database” are used interchangeably.

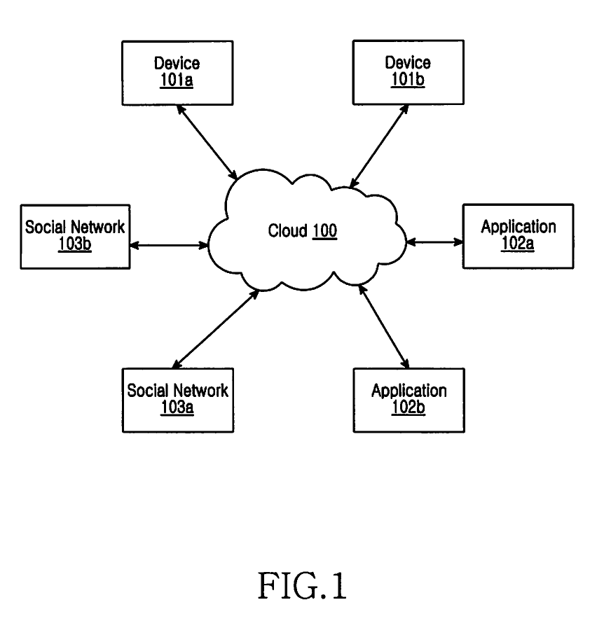

Referring now to the drawings, and more particularly to FIGS. 1 through 4, where similar reference characters denote corresponding features consistently throughout the figures, there are shown preferred embodiments.

FIG. 1 is a block diagram illustrating a system for dynamically changing a keypad language of a sender, based on the preferred language of the receiver, according to an embodiment of the present disclosure.

Referring to FIG. 1, the system comprises a plurality of devices, namely device 101a, device 102b; a plurality of applications (communication applications), which are application 102a, application 102b; and a plurality of social networks, such as social network 103a and social network 103b. These devices, communication applications and social networks exchange data with a cloud 100.

The devices 101a and 101b, applications 102a and 102b and the social networks 103a and 103b store the data in the cloud 100.

For example, the data present in the devices 101a and 101b is stored in the cloud 100. The data may include, but is not limited to, the contacts of the sender. Similarly the data present in different communication applications 102a and 102b, which may also include the contacts of the sender, is stored in the cloud 100. The social networks 103a and 103b are also connected to the cloud 100 for exchange of data.

The cloud 100 contains all the data that is present across all the devices 101a and 101b, communication applications 102a and 102b, and the social networks 103a and 103b. The data is updated by synchronizing the devices 101a and 101b, applications 102a and 102b, and the social networks 103a and 103b with the cloud 100.

For example, the contacts present in the devices 101a and 101b, applications 102a and 102b, and the social networks 103a and 103b are synchronized with the cloud 100 and updated accordingly.

If the sender of a device 101a has a stored contact in his/her device and has added a preferred language for communicating with the contact, the added preferred language for communicating with the contact may be updated by synchronizing with the cloud 100. The preferred languages set for the particular contact in any of the social networks 103a and 103b are obtained by syncing the device 101a with the cloud 100 and those language(s) are updated to the sender device for that particular contact.

According to an embodiment of the present disclosure, the preferred language used for communication with a receiver may be set by a sender in any of the communication applications 103a and 103b (for example, Instant Messenger). This preferred language is updated in the communication applications 103a and 103b of the sender by synchronizing with the cloud 100, where the cloud 100 may suggest, to the sender, the last used language as the keypad language for communicating with the receiver.

According to an embodiment of the present disclosure, when the devices 101a and 101b or applications 102a and 102b interact with the cloud 100, the data in the devices 101a and 101b and the applications 102a and 102b (for example, the contact details) may be synchronized with the data present in the cloud 100. For example, the device 101a and device 101 b exchange the data with one another by synchronizing with the cloud 100.

During synchronization with the cloud 100, the contacts present in the devices 101a and 101b and the applications 102a and 102b are updated in accordance with the data present in the cloud 100.

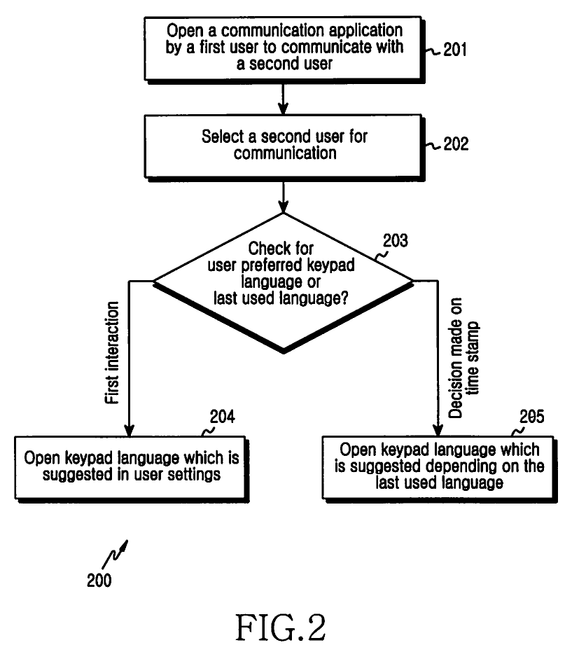

FIG. 2 is a flowchart illustrating a method of providing a keypad language to a sender, according to an embodiment of the present disclosure.

Referring to FIG. 2, the flow diagram 200 describes the steps involved in providing the desired keypad language to the sender. The method provides a keypad language to a sender for communicating with the receiver. The keypad language is provided to the sender based on the preferred language of the receiver or depending on the last language used for communicating with the receiver. The keypad language provided to the sender for communicating with the receiver is obtained from the language(s) set by the receiver in his/her social networks.

For example, if the sender adds the receiver in his/her contacts, then the method obtains the languages set by the receiver in any of the receiver's social networks and provides the keypad language to the sender.

According to an embodiment of the present disclosure, the sender can add his/her preferred language(s) in his contacts for communicating with the receiver. These preferred languages are also compared with the language(s) set by the receiver in his/her social networks and a common language (if exists) among these languages will be provided, to the sender, as the keypad language for communicating with the receiver.

According to the embodiment of the present disclosure described above, if there exists no common language between the sender's preferred languages and the languages set by the receiver in his/her social networks, then a default keypad language is provided to the sender as the keypad language for communicating with the receiver.

One or more fields are provided to a sender on his/her device 101a when the sender adds a contact to his/her device 101a. In those one or more fields, the sender can add multiple values of preferred languages for communicating with that contact. When the sender opens a communication application 102a and selects a contact, the method provides the keypad language as the preferred language identified in the one or more fields corresponding to the contact and based on a priority defined by the sender for the one or more fields.

According to an embodiment of the present disclosure, the sender can set the preferred language(s) for each of the contacts in his/her social networks 103a and 103b or in communication applications 102a and 102b. In this case, when the sender opens the communication application 102a and selects a contact to communicate, then the method provides the keypad language to the sender based on the preferred language(s) that are set for that contact according to the priority of the preferred language(s) as defined by the sender.

According to an embodiment of the present disclosure, when the devices 101a and 101b, applications 102a and 102b, and the social networks 103a and 103b are synchronized with the cloud 100 that stores all the data (including the contacts), the preferred language for each contact is updated after synchronizing with the cloud 100.

According to an embodiment of the present disclosure, if it is determined that the sender has communicated with a receiver using a language (for example language A) in the social network 103a or using the communication application 102a or using his/her own device 101a, then the last language (in this case language A) which is used for communication will be provided, to the sender, as a keypad language, whenever the sender tries to communicate with the receiver.

In the flowchart 200, at step 201, the sender opens a communication application on his/her device for communicating with a receiver. The application can be a communication application such as Instant Messenger (IM) or a message application within a device or any chat application present in any social network or the like.

The sender selects a particular contact from the contact list of his/her device or in the communication application or in his/her social network at step 202.

When the sender selects a particular contact for communication, in step 203, the method determines the preferred language set by the sender or the last language used, for communicating with the receiver.

In step 204, if there exists a preferred language set by the sender in his/her device settings or in the communication application settings, then the method provides, to the sender, the keypad language as that of the preferred language for communicating with the particular contact.

Alternatively, in step 205, the method may also suggest, to the sender, the last used language as the keypad language for communicating with the receiver. For example, consider that the sender and the receiver are communicating in a language (for example language A). After a certain time interval, the sender has removed the language A intentionally and starts communicating with the receiver in a language B, for example, then the method determines the last used language as language B and provides the keypad language as language B, whenever the sender tries to communicate with the receiver through his/her device or using an application or using his/her social networks. The various actions in flowchart 200 may be performed in the order presented, in a different order or simultaneously. Further, in some embodiments, some actions listed in FIG. 2 may be omitted.

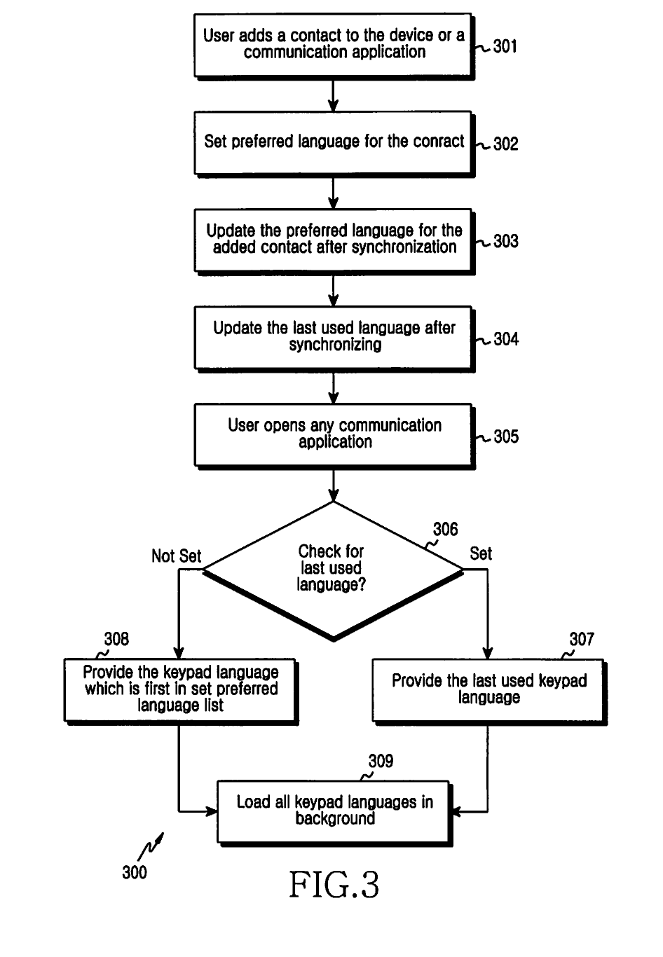

FIG. 3 is a flowchart illustrates a method of setting preferred languages, by a sender, for communicating with a receiver, according to an embodiment of the present disclosure.

Referring to FIG. 3, the flowchart 300 illustrates the method for obtaining the desired keypad language, by the sender, for communicating with the receiver. Further, in the flowchart 300 steps 301 to 304 describe the settings of the preferred language for a contact by a user in his/her device or in the communication application. The remaining steps (steps 305 to 309) describe the method for obtaining the keypad language for communicating with the receiver.

The sender adds a contact to his/her device or a communication application in step 301. When the sender adds the contact to his/her device or the communication application, one or more field is provided to the sender which is related to the contact, where the sender can set multiple values of preferred languages for communicating with the contact in step 302.

Once the sender has set a preferred language for communicating with the receiver in his/her device or in a communication application, the sender set preferred language, in the device or the communication application, may be updated after synchronizing with the cloud 100 in step 303.

Further, if it is determined that the sender has communicated with a receiver in a language (for example language A), the language A, which is used by the sender for communicating with the receiver is updated to the device or the communication application as a last used language in step 304. This last used language may also be updated to the social network of the sender through synchronization with the cloud 100. For example, when the sender opens a chat application on his/her social network for communicating with the receiver, the last used language (language A) is opened as a keypad language.

Once the preferred language settings are set by the sender in his/her device or in any communication application, these language settings are updated by synchronizing the device or the communication application with the cloud 100.

In step 305, the sender opens any communication application or any message application on his/her device for communicating with the receiver. When the sender opens the communication application, the method determines the last language used by the sender for communicating with the receiver at step 306. If the sender has set the last used language as the language for communicating with the receiver in his/her device or in the communication application, then, in step 307, the method provides, to the sender, the keypad language as last used language for communicating with the receiver.

If the sender has not set the last used language as the language for communicating with the receiver, then, in step 308, the method provides the keypad language to the sender based on the preferred languages set by the sender (for communicating with the receiver) in his/her device or in the communication application. For example, if the sender has set a preferred language for communicating with the receiver in his/her device or communication application as language A, then the language A is provided to the sender for communicating with the receiver.

Further, in step 308, if the sender has set multiple preferred languages for communicating with the receiver in his/her device or in the communication application, then the keypad language is provided to the sender based on the priority of the preferred languages defined by the sender. For example, if the sender has set the languages A, B and C for communicating with the receiver in his/her device or in the communication application and defines a priority for language A, then the keypad language for communicating with the receiver is provide to the sender in language A.

Further, in step 309, all of the keypad languages are loaded in the background of the sender device or the communication application and these keypad languages may be displayed to the sender as per the preferred keypad language of sender for communicating with the receiver. The various steps in flowchart 300 may be performed in the order presented, in a different order or simultaneously. Further, in some embodiments, some actions listed in FIG. 3 may be omitted.

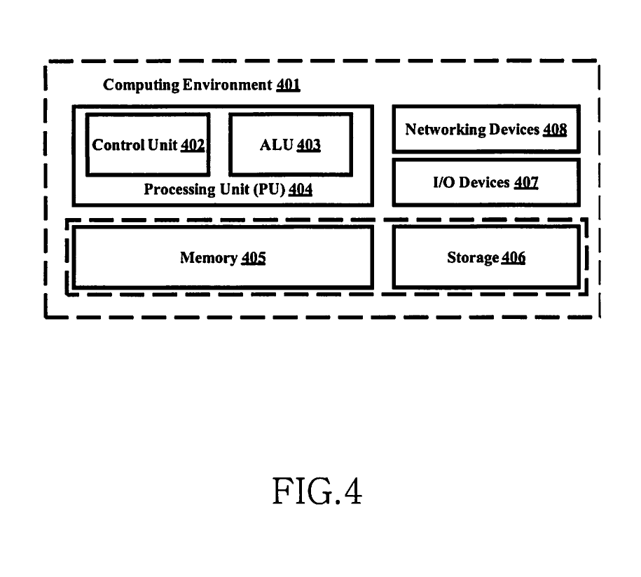

FIG. 4 illustrates an apparatus implementing the method and system for enabling a sender to communicate with a receiver, based on the preferred language of the receiver, according to an embodiment of the present disclosure;

Referring to FIG. 4, a device 401 is shown comprising at least one processing unit 404, which is equipped with a control unit 402 and an Arithmetic Logic Unit (ALU) 403, a memory 405, a storage unit 406, plurality of networking devices 408 and a plurality of Input output (I/O) devices 407. The processing unit 404 is responsible for processing the instructions of an algorithm. The processing unit 404 receives commands from the control unit in order to perform its processing. Further, any logical and arithmetic operations involved in the execution of the instructions are computed with the help of the ALU 403.

The apparatus 401 may be composed of multiple homogeneous and/or heterogeneous cores, multiple CPUs of different kinds, special media and other accelerators. The processing unit 404 is responsible for processing the instructions of the algorithm. Further, the plurality of processing units 404 may be located on a single chip or over multiple chips.

The algorithm is comprised of instructions and codes required for the implementation of the method of the present disclosure. The algorithm is stored in either the memory unit 405 or the storage 406 or both. At the time of execution, the instructions may be fetched from the corresponding memory 405 and/or storage 406, and executed by the processing unit 404.

In case of any hardware implementations, various networking devices 408 or external I/O devices 407 may be connected to the device to support the implementation through the networking unit and the I/O device unit.

The embodiments disclosed herein can be implemented through at least one software program running on at least one hardware device and performing network management functions to control the elements. The elements shown in FIGS. 1 and 4 include blocks which can be at least one of a hardware device, or a combination of hardware device and software module.

It will be appreciated that embodiments of the present disclosure according to the claims and description in the specification can be realized in the form of hardware, software or a combination of hardware and software.

Any such software may be stored in a non-transitory computer readable storage medium. The computer readable storage medium stores one or more programs (software modules), the one or more programs comprising instructions, which when executed by one or more processors in an electronic device, cause the electronic device to perform a method of the present disclosure.

Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape or the like. It will be appreciated that the storage devices and storage media are embodiments of machine-readable storage that are suitable for storing a program or programs comprising instructions that, when executed, implement embodiments of the present disclosure.

Accordingly, embodiments of the present disclosure provide a program comprising code for implementing an apparatus or a method as claimed in any one of the claims of this specification and a machine-readable storage storing such a program. Still further, such programs may be conveyed electronically via any medium such as a communication signal carried over a wired or wireless connection and embodiments suitably encompass the same.

The foregoing description of the specific embodiments will so fully reveal the general nature of the embodiments herein that others can, by applying current knowledge, readily modify and/or adapt for various applications, such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

What is claimed is:

1. A method for enabling a sender to communicate with a receiver, based on a preferred language of the receiver, the method comprising:
identifying the preferred language of the receiver, based on at least one parameter; and
providing the identified preferred language as a keypad language to the sender for communicating with the receiver.

2. The method of claim 1, the method further comprising:
synchronizing at least one contact of one of at least one device and at least one communication application with a database, the database for identifying the preferred language of the receiver,
wherein the at least one device and the at least one communication application is used by the sender.

3. The method of claim 1, wherein the parameter comprises one of languages set by the receiver in at least one Social Network Site (SNS)and languages preferred by the sender for communicating with the receiver.

4. The method of claim 1, wherein identifying the preferred language of the receiver comprises determining a last language used by the sender for communicating with the receiver, wherein the last language used by the sender is updated from one of a Social Network Service (SNS) and the at least one communication application.

5. The method of claim 3, wherein the languages preferred by the sender for communicating with the receiver are identified based on preferred language settings of the sender for communicating with said receiver.

6. The method of claim 5, the method further comprising providing at least one field in the preferred language settings in the at least one device, when the sender adds the receiver as a contact to the at least one device.

7. The method of claim 6, the method further comprising updating the at least one field in the preferred language settings by synchronizing the at least one contact in the at least one device from one of the at least one SNS and the at least one communication application.

8. A system for enabling a sender to communicate with a receiver, based on a preferred language of the receiver, wherein the system comprises:
at least one device;
at least one application on the at least device; and
at least one social network on the at least one device,
wherein the system is configured to perform the steps of:
identifying the preferred language of the receiver, based on at least one parameter; and
providing the identified preferred language as a keypad language to the sender for communicating with the receiver.

9. A apparatus for enabling a sender to communicate with a receiver, based on a preferred language of the receiver, the apparatus comprising:
an integrated circuit configured to include at least one processor and at least one memory; and
the at least one memory configured to include a computer program code,
wherein the computer program code is configured to perform the steps of:
identifying the preferred language of the receiver, based on at least one parameter; and
providing the identified preferred language as a keypad language to the sender for communicating with the receiver.

10. The apparatus of claim 9, is the apparatus further configured to synchronize one of at least one contact of one of at least one device and at least one communication application with a database, the database for identifying the preferred language of the receiver, wherein the at least one device and the at least one communication application is used by the sender.

11. The apparatus of claim 9, wherein the parameter comprises one of languages set by the receiver in at least one Social Network Site (SNS) and languages preferred by the sender for communicating with the receiver.

12. The apparatus of claim 9, wherein identifying the preferred language of the receiver comprises determining a last language used by the sender for communicating with the receiver, wherein the last language used by the sender for communication is updated from one of a Social Network Site (SNS) and the at least one communication application.

13. The apparatus of claim 11, wherein the apparatus is further configured to identify the languages preferred by the sender for communicating with the receiver based on preferred language settings of the sender.

14. The apparatus of claim 13, the apparatus further configured to provide at least one field in the preferred language settings in the at least one device, when the sender adds the receiver as a contact to the at least one device.

15. The apparatus of claim 14, the apparatus further configured to update the at least one field in the preferred language settings by synchronizing the at least one contact in the at least one device from one of the at least one SNS and the at least one communication application.
